(19) United States
(12) Patent Application Publication
(10) Pub. No.: US 2006/0097616 A1
(43) Pub. Date: May 11, 2006

(54) Lamp

(76) Inventors: Nobuharu Hata, Oku-gun (JP); Eiichiro Toriumi, Utsunomiya-shi (JP); Tetsuo Matsuba, Neyagawa-shi (JP)

Correspondence Address: SNELL & WILMER LLP, 600 ANTON BOULEVARD, SUITE 1400, COSTA MESA, CA, 92626, US

(21) Appl. No.: 10/512,743

(22) PCT Filed: May 8, 2003
(86) PCT No.: PCT/JP03/05752

§ 371 Date: Dec. 19, 2005

(30) Foreign Application Priority Data
May 9, 2002 (JP) 2002-134649

(51) Int. Cl. H01J 5/48; H01J 5/50

(52) U.S. Cl. 313/318.01

(57) ABSTRACT

A lamp (1) including: a straight arc tube (10); and a pair of bases (20). Each base includes: a base body (30) fixed to an end of the arc tube (10); and a terminal attachment body (40) fixed to the base body (30) being shaped like a cap and including: a cylindrical body (31); and an opening (33). The terminal attachment body (40) includes a protuberant portion (43) that is oval and protrudes in a direction opposite to the arc tube along the tube axial. While the protuberant portion (43) protrudes through the opening (33), the terminal attachment body (40) is fixed to the base body (30) by the knurling method in which the peripheral of the end portion of the cylindrical body (31) is given a pressure so as to be knurled and embedded into the terminal attachment body (40).

### TECHNICAL FIELD

The present invention relates to a lamp that includes a straight arc tube where a base is attached to each of two ends thereof, each base having a pair of terminals.

### BACKGROUND ART

A straight-tube-type fluorescent lamp (hereafter referred to as a lamp) includes a straight arc tube. Two bases are fixed to the arc tube at both ends thereof so that electric current is applied to the arc tube via the bases. Lamps with various lengths are manufactured for different uses in location and purpose. The brightness of the lamp changes as its length changes. Also, as the arc tube becomes longer, the discharge start voltage becomes higher. In general, what is called G13 base is used in short lamps, and what is called R17d base is used in long lamps. The R17d base is used, for example, in a lamp being 2,367 mm in length.

FIG. 1 is a top plan view of an arc tube to which the conventional R17d base (hereafter referred to as a base) is attached. FIG. 2 is a cutaway front view of the arc tube shown in FIG. 1. As shown in FIG. 2, a conventional base 120 includes: (i) a metal base body 121 to be attached to an end of an arc tube 110, and (ii) a terminal attachment body 130 which is made of a synthetic resin and is fixed to the base body 121. The base body 121 is shaped like a cap, and is composed of a cylindrical body 122 and an end wall 123. The base body 121 has a circular opening 124 that is encircled by the end wall 123. The inner surface of the cylindrical body 122 is fixed to the end of the arc tube 110 by cement 125.

The terminal attachment body 130 includes: a disk-shaped bottom 131 that is placed inside the base body 121; a fitting portion 132 that protrudes from the bottom 131 in a direction opposite to the arc tube 110 so as to fit into the opening 124; and a protuberant portion 133 that protrudes from the fitting portion 132 in the direction opposite to the arc tube 110 along the tube axial of the arc tube 110.

The protuberant portion 133 is, when viewed from above, oval, and has a pair of terminals 134 that are arranged inside thereof along the direction of the length of the protuberant portion 133. When the protuberant portion 133 is inserted into the entry of a socket (not illustrated), the terminals 134 of the protuberant portion 133 contact electrically with terminals in the socket, which allows the electric current to be applied to the arc tube.

The terminal attachment body 130 is fixed to the base body 121 through the following procedures. First, the terminal attachment body 130 is inserted into the opening 124 of the base body 121 so that the protuberant portion 133 protrudes from the opening 124 and the bottom 131 is in contact with the inner surface of the end wall 123. While the terminal attachment body 130 is in contact with the base body 121 in this way, pressure is given from outside to an end portion of the cylindrical body 122 near the end wall 123 by the knurling method. That is to say, a pressure is given to the peripheral of the end portion of the cylindrical body 122 so that the portion is knurled and embedded into the terminal attachment body 130.

In a lamp 101 using the conventional base 120, the arc tube 110 is 38 mm in diameter, and the opening 124 is 22.76 mm in diameter to provide adequate insulation between the terminals 134 and the base body 121.

Meanwhile, in recent years, arc tubes with smaller diameters (for example, 25 mm) have been developed to meet the demand for improvement in the lamp efficiency and design. However, there is a problem in such arc tubes. That is to say, it is difficult to fix the bases to the arc tubes. If the base is reduced in diameter to match the diameter (25 mm) of the arc tube, but has an opening with the same diameter as before (22.76 mm), for example, it is difficult to fix the base to the terminal attachment body of the arc tube.

More particularly, since the length of the end wall between the opening and the rim thereof along a diameter of the base is very small, the end wall of the base is very low in stiffness. As a result, the end wall is deformed if the base is tried to be fixed to the arc tube by the knurling method.

### DISCLOSURE OF THE INVENTION

It is therefore the object of the present invention to provide a lamp in which a base is fixed to an arc tube that is small in diameter (for example, 25 mm), the lamp at the same time providing electrical insulation between the terminal attachment body and the base body.

The first object can be achieved by a lamp comprising: a straight arc tube; and a pair of bases which each have a pair of terminals, and are each attached to an end of the arc tube, wherein each base includes: a base body that is shaped like a cap and has an opening in the center of an end wall that is an end surface of the base body; and a terminal attachment body to which the pair of terminals are attached, the terminal attachment body being fixed to the base body with the terminals being protruded from the opening, and a length of the end wall between the opening and a rim thereof along a diameter of the base is no smaller than an insulation distance that is defined in a standard for a purpose of keeping the base electrically safe, and the base has a portion where the length of the end wall exceeds a length of the end wall between the opening and the rim thereof in a direction in which the pair of terminals align.

With the above-described construction, the end wall of the base body has a portion in which the length of the end wall between the opening and the rim thereof is large. This prevents the end wall from being deformed during, for example, the knurling working. Also, the insulation between the terminal and the base body is ensured since the distance between the rim of the opening and the terminal attachment body in the direction in which the pair of terminals align is enough.

In the above lamp, the length of the end wall between the opening and the rim thereof may be the shortest in the direction in which the pair of terminals align.

In the above lamp, the length of the end wall in the direction in which the pair of terminals align may be no smaller than 19 mm, and the length of the end wall in a direction perpendicular to the direction in which the pair of terminals align is no smaller than 11 mm and smaller than 19 mm.

In the above lamp, the opening may be oval and long in the direction in which the pair of terminals align.

With the above-described construction, the end wall of the base body has a portion in which the length of the end wall between the opening and the rim thereof is large. This reduces the deformation of the end wall from even if the knurling method is used in fixing the base body to the terminal attachment body. Also, the insulation between the terminal and the base body is ensured since the distance between the rim of the opening and the terminal attachment body in the direction in which the pair of terminals align is enough.

In the above lamp, the terminal attachment body may include a protuberant portion that is oval in a cross-sectional view and protrudes in a direction opposite to the arc tube along a tube axial of the arc tube, and the pair of terminals are attached to the terminal attachment body in an upper hollow of the protuberant portion so that the direction in which the pair of terminals align is substantially equal to a direction of length of the oval of the protuberant portion.

With the above-described construction, both the opening and the protuberant portion have the same shape, namely an oval shape. This improves the design of the lamp.

In the above lamp, the terminal attachment body may include a disk-shaped bottom connected to the protuberant portion, the bottom and the protuberant portion having a same center, and the terminal attachment body is fixed to the base body with a pressure given to a rim of the bottom from the end wall of the base body.

With the above-described construction, it is possible to fix the terminals to the base body easily by, for example, knurling the rim of the base body near the end wall.

In the above lamp, the terminal attachment body may include a fitting portion that is formed between the protuberant portion and the bottom and fits into the opening.

The above-described construction enhances the torsional rigidity between the terminal attachment body and the base body.

In the above lamp, two lead wires may come out from each end portion of the arc tube and may be respectively connected to the pair of terminals electrically, and the terminal attachment body further includes: two guide holes which guide the lead wires to positions where the lead wires are connected to the pair of terminals, respectively; and two metal members which are deposited in the guide holes and are electrically connected to the pair of terminals, respectively; and two pressing members that press the lead wires in the guide holes against the metal members, respectively.

With the above-described construction, it is possible to connect the terminals to the lead wires electrically with reliability. It should be noted here that the “metal members electrically connected to the pair of terminals” may be the terminals themselves.

In the above lamp, the terminal attachment body may have two protuberant walls that protrude from a surface of the bottom toward the arc tube, surrounding the guide holes, respectively.

The above-described construction prevents adherence of dust or the like to the lead wires.

In the above lamp, the terminal attachment body may include a disk-shaped bottom under the protuberant portion, the bottom and the protuberant portion having a same center, and a surface of the bottom on the side of the protuberant portion is fixed to an inner surface of the end wall of the base body.

With the above-described construction, it is possible to easily fix the terminals to the base body by an adhesive.

In the above lamp, the terminal attachment body may include a fitting portion that is formed between the protuberant portion and the bottom and fits into the opening.

The above-described construction enhances the torsional rigidity between the terminal attachment body and the base body.

In the above lamp, two lead wires may come out from each end portion of the arc tube and may be respectively connected to the pair of terminals electrically, and the terminal attachment body further includes: two guide holes which guide the lead wires to positions where the lead wires are connected to the pair of terminals, respectively; and two metal members which are deposited in the guide holes and are electrically connected to the pair of terminals, respectively; and two pressing members that press the lead wires in the guide holes against the metal members, respectively.

With the above-described construction, it is possible to connect the terminals to the lead wires electrically with reliability. It should be noted here that the “metal members electrically connected to the pair of terminals” may be the terminals themselves.

In the above lamp, the terminal attachment body may have two protuberant walls that protrude from a surface of the bottom toward the arc tube, surrounding the guide holes, respectively.

The above-described construction prevents adherence of dust or the like to the lead wires.

### BRIEF DESCRIPTION OF THE DRAWINGS

FIG. 1 is a top plan view of an end portion of a conventional straight-tube-type fluorescent lamp.

FIG. 2 is a cutaway front view of the conventional straight-tube-type fluorescent lamp.

FIG. 3 is a perspective view of an end portion of the straight-tube-type fluorescent lamp of an embodiment of the present invention.

FIG. 4 is a top plan view of an end portion of the straight-tube-type fluorescent lamp of the embodiment of the present invention.

FIG. 5 is a cutaway front view of an end portion of the straight-tube-type fluorescent lamp of the embodiment of the present invention.

FIG. 6 is a cutaway side view of an end portion of the straight-tube-type fluorescent lamp of the embodiment of the present invention.

FIG. 7 is a sectional view taken substantially along line A-A of FIG. 5, and viewed from the direction indicated by the arrows in FIG. 5.

FIG. 8 shows the results of the torsional rigidity test conducted for conventional and present-embodiment lamps.

FIG. 9 is a top plan view of an end portion of a straight-tube-type fluorescent lamp as a variation of the present invention.

FIG. 10 is a cutaway front view of a straight-tube-type fluorescent lamp as a variation of the present invention.

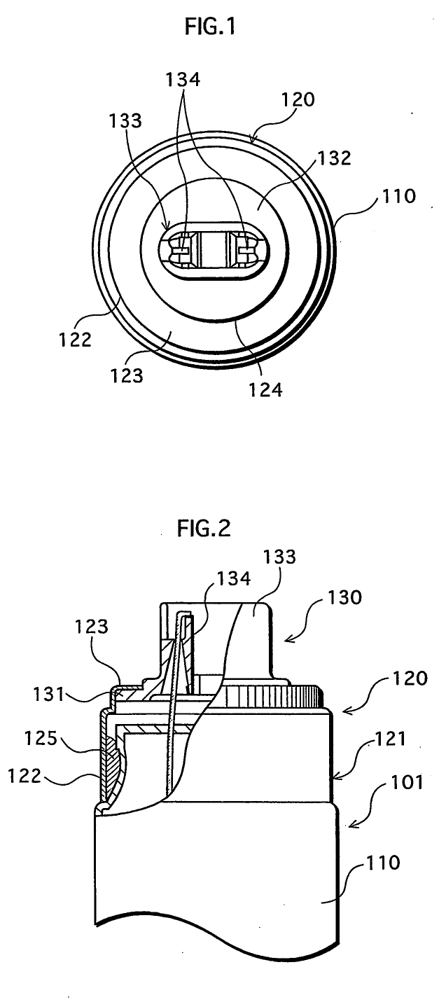

### BEST MODE FOR CARRYING OUT THE INVENTION

The following describes a straight-tube-type fluorescent lamp that is an embodiment of the present invention, with reference to the attached figures.

1. Structure of Straight-Tube-Type Fluorescent Lamp

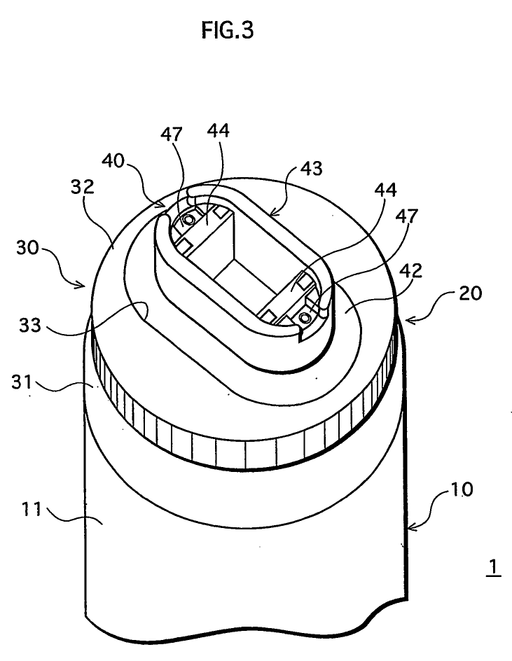

FIG. 3 is a perspective view of an end portion of the straight-tube-type fluorescent lamp of the present invention.

As shown in FIG. 3, a straight-tube-type fluorescent lamp 1 (hereafter referred to as lamp 1) includes a straight arc tube 10 and a base 20, where the base 20 is fixed to an end of the arc tube 10. Electric current is applied to the arc tube 10 via sockets (not illustrated) and the bases 20. It should be noted here that though FIG. 3 shows that the base 20 is fixed to one end of the arc tube 10, the base is also fixed to the other end of the arc tube 10.

The arc tube 10 includes a cylindrical glass tube 11. The inner surface of the glass tube 11 is coated with a protecting film and a fluorescent film. The arc tube 10 is filled with mercury vapor, rare gas, or the like. Electrodes are attached to both end surfaces of the arc tube 10. If a lamp current is applied to the electrodes via the bases 20, thermal electrons are emitted from the electrodes and collide with atoms of mercury. Ultraviolet rays emitted by this collision excite the fluorescent film, allowing visible light to be emitted. The arc tube 10 has an external diameter of 25 mm.

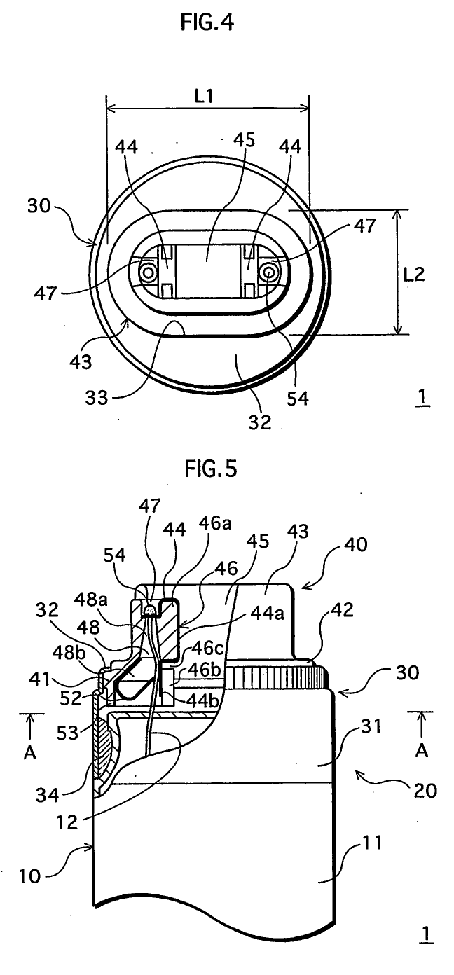

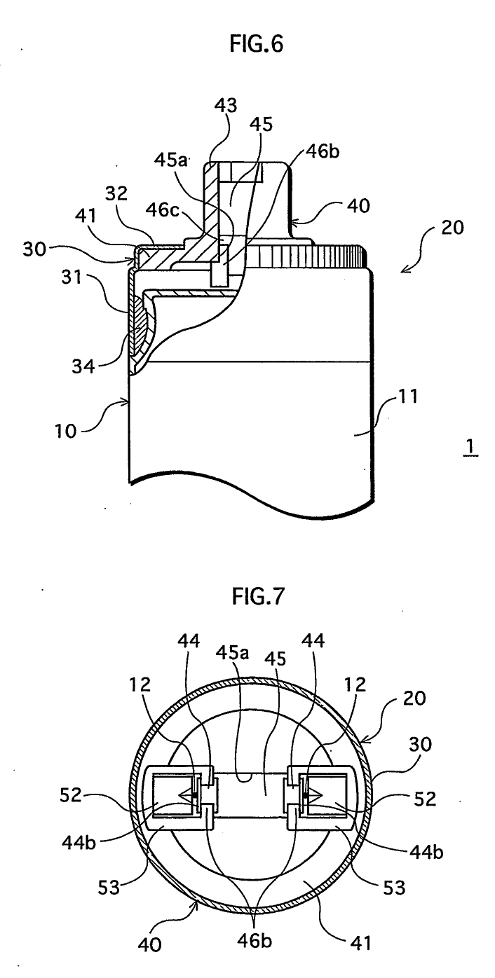

FIG. 4 is a top plan view of the lamp 1. FIG. 5 is a cutaway front view of the lamp 1. FIG. 6 is a cutaway side view of the lamp 1.

The base 20 is what is called R17d base, and as shown in FIGS. 3-6, includes a base body 30 and a terminal attachment body 40. The base body 30 is fixed to an end of the arc tube 10. The terminal attachment body 40 is fixed to the base body 30.

The terminal attachment body 40 includes a protuberant portion 43 which is oval when viewed from above and protrudes in a direction opposite to the arc tube 10 along the tube axial of the arc tube 10. A pair of terminals 44 are arranged inside the protuberant portion 43 along the direction of the length of the protuberant portion 43, the distance between the terminals 44 conforms to the JIS (Japanese Industrial Standards) C-7709.

The shape of the protuberant portion 43 meets the values defined in the JIS C-7709 standard. When the protuberant portion 43 is inserted into the entry of a socket (not illustrated), the lamp 1 contacts electrically with the socket. It should be noted here that in the following description, the horizontal direction in FIG. 4 is referred to as “the direction of the length”, and the vertical direction in FIG. 4 is referred to as “the direction of the width”.

The base body 30 is shaped like a cap, and is composed of a cylindrical body 31 and an end wall 32. The base body 30 has an opening 33 in the center of the end wall 32. The opening 33 is not circular, but is oval in this example. The base body 30 is made of metal, for example, aluminum. As shown in FIG. 5, the lower portion of the terminal attachment body 40 is fixed to an inner surface of the base body 30 near the end wall 32.

Also, the inner surface of the cylindrical body 31 is fixed to an end portion of the arc tube 10 by cement 34.

The reason for using the cement 34 to fix the base body 30 to the arc tube 10 is that it has a high adhesion intensity.

The reason for using aluminum for the base body 30 is that it is stronger than resin and highly weather-resistant.

As shown in FIG. 4, the opening 33 is oval when viewed from above, and the oval shape of the opening 33 correspondents to the oval shape of the protuberant portion 43. The opening 33 measures 20 mm (L1) in the direction of the length, and 12 mm (L2) in the direction of the width. This oval shape is formed by cutting the edges of a 12 mm×8 mm rectangle to form curvature of a circle having a diameter of 12 mm.

As shown in FIGS. 5 and 6, the terminal attachment body 40 includes: a disk-shaped bottom 41 that is placed inside the base body 30; a fitting portion 42 that protrudes from the bottom 41 in a direction opposite to the arc tube 10 so as to fit into the opening 33; and the protuberant portion 43 that protrudes from the fitting portion 42 in the direction opposite to the arc tube 10. The direction of the length of the protuberant portion 43 is substantially equal to the direction of the length of the fitting portion 42.

FIG. 7 is a sectional view taken substantially along line A-A of FIG. 5, and viewed from the direction indicated by the arrows in FIG. 5.

As shown in FIGS. 3-7, the protuberant portion 43 has a through hole 45 that passes through substantially the center of the protuberant portion 43 along the tube axial of the arc tube 10. It should be noted here that the through hole 45 is formed to fit the entry of the socket. The dimensions of the through hole are defined in the JIS C7709 standard.

As shown in FIGS. 4 and 5, on either side of the through hole 45 along the direction of the length of the protuberant portion 43, formed are: a terminal holding unit 46 for holding the terminal 44; a concave 47 formed at the outer side of the terminal holding unit 46 along the direction of the length of the protuberant portion 43; and a guide hole 48 that guides a lead wire 12, which comes out from the end portion of the arc tube 10, into the concave 47.

The terminal holding unit 46 includes a first holding unit 46a for holding the terminal 44; and a second holding unit 46b for holding the terminal 44 on the side of the arc tube 10.

In FIG. 6, it appears that the second holding unit 46b protrudes from a surface 45a into the through hole 45, the surface 45a being formed along a direction in which the pair of terminals 44 align. However, as will be described later, the second holding unit 46b is part of a protuberant wall 53 that surrounds a second guide hole 48b, the part extending into the through hole 45. As shown in FIG. 5, after the terminal 44 is attached to the first holding unit 46a, the second holding unit 46b is in contact with an extension 44b (which will be described later) of the terminal 44.

The terminal 44 is made of a metal and is formed to be deformable. The terminal 44 includes a letter-C-shaped portion 44a; and an extension 44b that extends along the tube axial of the arc tube 10 from a lower end of the letter-C-shaped portion 44a.

As shown in FIG. 5, un upper end of the letter-C-shaped portion 44a covers a bottom surface of the concave 47 after the terminal 44 is attached to the first holding unit 46a. Also, as shown in FIGS. 5 and 6, a gap 46c is formed between the first holding unit 46a and the second holding unit 46b. The gap 46c is used when the extension 44b is placed at the back of the second holding unit 46b during the attachment of the terminal 44 to the terminal holding unit 46.

The following steps are taken to attach the terminal 44 to the terminal holding unit 46. First, the extension 44b is inserted into the gap 46c between the first holding unit 46a and the second holding unit 46b so that the end of the extension 44b contacts the upper end of the second holding unit 46b shown in FIG. 5. Next, the letter-C-shaped portion 44a is fit onto the first holding unit 46a by widening its opening. This allows the extension 44b to be placed at the back of the second holding unit 46b, completing the attachment of the terminal 44 to the terminal holding unit 46.

The bottom of the concave 47 has a hole through which an end of the lead wire 12 comes out side the terminal 44. Similarly, the upper portion of the terminal 44 covering the bottom surface of the concave 47 has a hole for the same purpose. The end of the lead wire 12 coming out through the holes is connected and fixed to the surface of the terminal 44 by, for example, welding. A wire connection portion 54 at which the lead wire 12 is connected to the terminal 44 is shown in FIGS. 4 and 5.

As shown in FIG. 5, the guide hole 48 is composed of a first guide hole 48a and a second guide hole 48b that are connected together, where the first guide hole 48a is formed under the bottom of the concave 47 to extend along the tube axial of the arc tube 10, and the second guide hole 48b is formed to extend from the first guide hole 48a toward the arc tube 10.

The cross-sectional area of the first guide hole 48a gradually increases as the hole deepens from under the bottom of the concave 47 toward the arc tube 10.

As shown in FIGS. 5 and 7, initially, the second guide hole 48b has an opening through which the second guide hole 48b is connected to the through hole 45. However, the opening is blocked by the extension 44b of the terminal 44 after the terminal 44 is attached to the terminal holding unit 46.

The second guide hole 48b widens as it deepens and has an oblique surface extending on the back of the surface of the base body 30. A pressing member 52 is attached to the oblique surface so that it presses the lead wire 12 against the extension 44b of the terminal 44.

The pressing member 52 is, for example, a letter-U-shaped thin metal plate, and the metal plate 52 is attached, at one flat portion thereof, to the oblique surface of the second guide hole 48b. When the lead wire 12 is inserted into the guide hole 48, the pressing member 52 is distorted away to help the lead wire 12 proceed toward the concave 47. On the other hand, when the inserted lead wire 12 is pulled from under the guide hole 48, the pressing member 52 is distorted toward the lead wire 12 to prevent the lead wire from being removed from the guide hole 48.

As shown in FIG. 5, the bottom 41 of the terminal attachment body 40 has a protuberant wall 53 that protrudes from the bottom 41 toward the arc tube 10, surrounding the guide hole 48. The protuberant wall 53 is formed to prevent any adherence of, for example, dust or metal powder to the lead wire 12. This is because such adherence of dust or the like to the lead wire 12 may cause a short circuit or the like.

It should be noted here that as shown in FIG. 7, the second holding unit 46b of the terminal holding unit 46 is part of the protuberant wall 53.

2. Assembling Method

(1) Assembling of Base

First, the terminal 44 is attached to the protuberant portion 43 of the terminal attachment body 40. The terminal attachment body 40 is then fixed to the base body 30 by first inserting the terminal attachment body 40 into the base body 30 so that the fitting portion 42 fits into the opening 33 of the base body 30, and the upper rim of the bottom 41 is in contact with the inside of the end wall 32 of the base body 30. While the terminal attachment body 40 and the base body 30 are in this state, the end portion of the cylindrical body 31 near the end wall 32 is knurled, so that the pressed portion is embedded into the terminal attachment body 40, and the terminal attachment body 40 is fixed to the base body 30.

In the above-stated fixation, the terminal attachment body 40 and the base body 30 can be positioned easily since the fitting portion 42 fits into the opening 33 of the base body 30. Also, since both the opening 33 and the fitting portion 42 are oval, the terminal attachment body 40 and the base body 30 do not shift by rotation about the axis while the knurling is made.

Also, since the opening 33 is oval, the area where the terminal attachment body 40 overlaps the end wall 32 is larger than that in the conventional lamps, which have circular openings. Accordingly, when the base body 30 is knurled at the rim near the end wall 32, the terminal attachment body 40 is stable, and the end wall 32 is not deformed.

Also, that both the opening 33 and the protuberant portion 43 are oval when viewed from above contributes to the improvement of the design of the base 20.

(2) Attaching Base to End of Arc Tube

The base 20 is assembled as described above. Now, how to attach the base 20 to the arc tube 10 will be described.

In the first step, an end of the lead wire 12, which comes out from an end of the arc tube 10, is inserted into the guide hole 48 of the terminal attachment body 40, and pulled out into the concave 47 through the holes of the bottom of the concave 47 and the terminal 44. In this procedure, the lead wire 12 is easily guided into the concave 47 since the guide hole 48 widens as it deepens toward the arc tube 10.

Also, though the lead wire 12 is easily guided into the concave 47, it is difficult to remove the inserted lead wire 12 from the guide hole 48 since the pressing member 52, which presses the lead wire 12 against the terminal 44, has been attached to the inside of the guide hole 48. In other words, the process of guiding the lead wire into the concave includes the process of temporarily fixing the lead wire to the terminal 44.

In the next step, first cement is applied to the inner surface of the cylindrical body 31 of the base body 30 before the cement hardens; the base body 30 is placed on top of the arc tube 10; then the cylindrical body 31 is heated to harden the cement 34 while the cylindrical body 31 is in contact with the arc tube 10.

To heat the cylindrical body 31 to harden the cement, the base 20 must be correctly positioned with reference to the arc tube 10. If the conventional base 120 for the arc tube 110 being 38 mm in diameter is applied to the arc tube 10 of the present embodiment being 25 mm in diameter, it is expected that there would be no portion of the base by which the base is held since the end wall is small in area, and that this would tend to cause the base to be fixed to the arc tube 10 with a positional shift between them. In contrast, the base 20 of the present embodiment has relatively broad portions on either side of the opening 33 along the direction of the width of the opening 33. Accordingly, it is possible to position the base 20 with reference to the arc tube 10 easily and correctly by holding the base 20 at these broad portions.

In the last step, the lead wire 12 is fixed to the terminal 44 in the concave 47 so that they are electrically connected to each other. For example, the end of the lead wire 12 is fixed to the surface of the terminal 44 by welding or soldering. The lamp 1 is completed after the same procedure is applied to the other end of the arc tube 10.

It should be noted here that welding is more preferable than soldering when the following factors are taken into consideration: (1) the lead solder has become an environmental issue in recent years; (2) reliability of the adhesive strength between the arc tube 10 and the base body 30 after the base 20 reaches a high temperature when the lamp 1 is lighted; and (3) the cost. Recently, lead-less solder has been developed. However, even if the factor (1) above is removed from consideration, it is thought that welding is more preferable than soldering when comparison is made in terms of the factors (2) and (3) above.

The lead wire 12 is pressed against the extension 44b of the terminal 44 by the pressing member 52 in the second guide hole 48b of the guide hole 48. This allows the lead wire 12 to be electrically connected to the terminal 44 with reliability. The lead wire 12 is also electrically connected to the terminal 44 by the welding in the concave 47. This dual connection makes reliability of the electrical connection between the lead wire 12 and the terminal 44 extremely high.

The lamp 1 can be assembled easily as described above, and is also electrically safe and has high torsional rigidity.

Here, the electrical safety will be discussed first. In the base 20 constructed as described above, the creepage distance of insulation between the terminal 44 and the base body 30 is the shortest in the direction in which the pair of terminals 44 align. The actually measured values of the creepage distance of insulation between the terminal 44 and the base body 30 in the direction in which the pair of terminals 44 align were no less than 6 mm. This satisfies the JIS C7709 standard which defines that the creepage distance of insulation should be no less than 6 mm. Accordingly, it was confirmed that the lamp 1 of the present embodiment is electrically safe.

Also, the construction in which the terminal 44 is connected to the lead wire 12 in the concave 47 enhances the electrical safety since the creepage distance of insulation between the terminal 44 and the base body 30 increases by the difference in distance between the straight line on a flat surface and the lines along the concaves.

The bottom 41 of the terminal attachment body 40 has the protuberant wall 53 that protrudes from the bottom 41 toward the arc tube 10 and prevents adherence of dust or the like to the lead wire 12. There is, however, another effect of the protuberant wall 53. That is to say, the protuberant wall 53 increases the creepage distance of insulation between the terminal 44 and the base body 30 in the base 20. Also, since the protuberant wall 53 is formed to surround the guide hole 48 on the side of the arc tube 10, the space in the guide hole 48 for containing the pressing member 52 increases.

Next, the torsional rigidity will be discussed.

In the conventional base 20, the opening 124 of the base. body 121 is circular, and the fitting portion 132 of the terminal attachment body 130 is also circular. With such a construction, it often happens that when the terminal attachment body 130 receives a torsional load when being rotated about the tube axial of the arc tube, the terminal attachment body 130 is detached from the base body 121 easily. For example, when the conventional lamp 101 is of a type in which it should be rotated once so as to be attached to the socket, the user may rotate the lamp 101 incorrectly and give the torsional load to the terminal attachment body 130.

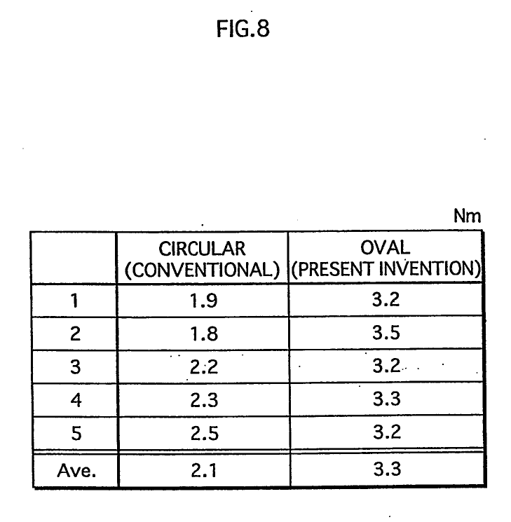

To compare the base 20 of the present embodiment with the conventional base 120 in regard with the torsional rigidity, a torsional test was conducted. In the torsional test, the torsional rigidity (Nm) was measured by applying a torsional load to the terminal attachment body while fixing the base body, for each test sample of the conventional and present-embodiment lamps. The test was conducted five times for each of the conventional and present-embodiment lamps. FIG. 8 shows the results.

As shown in FIG. 8, the average values of the five tests for the base 20 of the present embodiment and the conventional base 120 were 3.3 (Nm) and 2.1 (Nm), respectively. That is to say, it was confirmed that the base of the present embodiment is superior to the conventional base in terms of the torsional rigidity. It is considered that this is because in the present embodiment, both the opening 33 and the fitting portion 42 are oval and fit to each other.

Variations

The present invention has been explained above through an embodiment thereof. However, the present invention is not limited to the embodiment, and can be varied as follows, for example.

(1) Opening of Base Body

In the above embodiment, the opening of the base body is oval. Not limited to this, the opening may have other shapes in so far as the length of the end wall between the opening and the rim thereof in the direction in which the pair of terminals 44 align is smaller than the lengths of the end wall in the other directions along the diameter of the base. Then, the base has relatively broader portions than the conventional base having a circular opening. This prevents the end wall from being deformed to some extent. However, to prevent the end wall from being deformed with reliability, it is preferable that the opening is oval as described in the present embodiment and shown in the attached drawings.

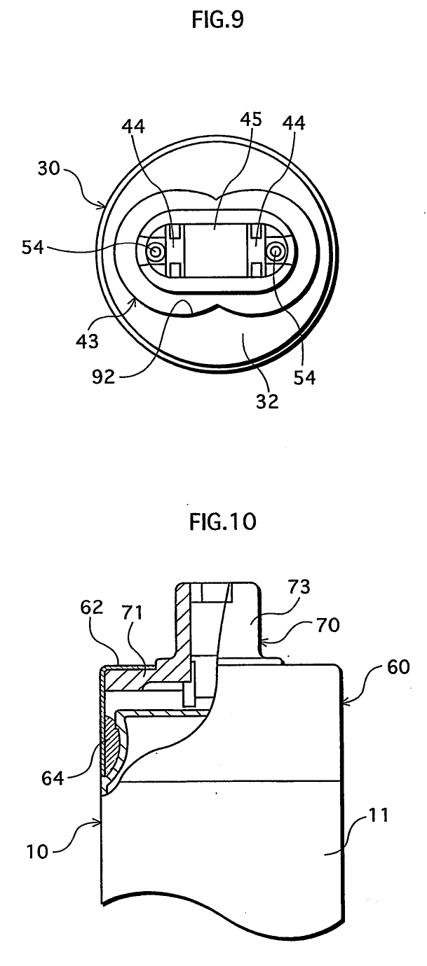

The opening may have a shape shown in FIG. 9 in which 92 represents the opening. The opening 92 is shaped like two circles combined together to overlap in the direction in which the pair of terminals 44 align. FIG. 9 shows an example of the shape in which each circle constituting the shape has a radius of 6 mm, where the center of each circle is substantially equal to the center of each terminal. This shape of the opening is not limited to these dimensions, though. The shape of the opening provides the same effects as the oval shape of the present embodiment. Both in the present embodiment and this example, the opening has curves. However, the opening may have straight lines.

In the present embodiment, the opening 33 of the base body 30 measures as: L1=20 mm; and L2=12 mm, where, as shown in FIG. 4, L1 represents the length of the opening in the direction in which the pair of terminals align, and L2 represents the length of the opening in a direction perpendicular to the direction in which the pair of terminals align. However, L1 may be no smaller than 19 mm, and L2 may be no smaller than 11 mm and smaller than 19 mm.

It should noted here that the above dimensions of the opening (L1=20 mm, L2=12 mm) in the present embodiment were determined not only because it provides reliable insulation between the terminals and the base body for electrical safety, and makes it easy for the terminal attachment body to be fixed to the base body, but also from the view point of the design of the base.

(2) Fixing Terminal Attachment Body to Base Body

In the present embodiment, the terminal attachment body is fixed to the base body by knurling the end portion of the cylindrical body of the base body near the end wall. However, the fixation may be done by other methods.

FIG. 10 shows an example of a fixation method other than the knurling method. In this method, an adhesive is used to fix a surface of a bottom 71 of a terminal attachment body 70 on the side of a protuberant portion 73 to the inner surface of an end wall 62 of abase body 60. This method is more effective in the lamps having oval openings than in the conventional lamps having circular openings. This is because the area where the terminal attachment body overlaps the end wall is larger in the lamps having oval openings, providing a larger area to which the adhesive is applied, thus higher adhesive strength, than in the conventional lamps.

It should be noted here that the adhesive used to fix the terminal attachment body to the base body should be heat-resistant. This is because the terminal attachment body 70 may be heated as the base body 60 is heated when the base body 60 is fixed to the arc tube 10.

Further, the terminal attachment body may be formed in one piece with the base body. This provides the same effects as the above-described method in which the terminal attachment body is fixed to the base body by an adhesive.

(3) Terminal Attachment Body

In the present embodiment, the guide hole 48 is composed of the first guide hole 48a and the second guide hole 48b, as shown in FIG. 5. However, the guide hole may be a through hole that passes through the protuberant portion, as shown in FIG. 2. In this case, it is required that the cross-sectional area of the through hole increases as it deepens toward the arc tube to keep a space enough to attach the pressing member therein.

(4) Terminal

In the present embodiment, the letter-C-shaped portion and the extension are formed as one piece. However, the letter-C-shaped portion and the extension may be provided separately, and they may be electrically connected with each other by the lead wire or the like. In this case, the letter-C-shaped portion corresponds to the terminal, and the extension corresponds to the metal member.

(5) Others

In the present embodiment, the arc tube has an external diameter of 25 mm. However, not limited to this, the arc tube may have other diameters. The length of the opening of the base body in the direction in which the pair of terminals align should be determined by taking the insulation between the terminals and the base body into account and should not exceed, off course, the internal diameter of the cylindrical body.

In the present embodiment, a cylindrical arc tube is used. However, not limited to this, arc tubes being oval or polygon in a cross-sectional view may be used. Also, in the present embodiment, a fluorescent lamp is used, where the inner surface of the fluorescent lamp is coated with a fluorescent film. However, a lamp having an arc tube not coated with a fluorescent film, such as the black lamp, may be used.

In the present embodiment, the R17d base is used. However, it is possible to apply the present embodiment to the G13 base by removing the protuberant portion from the terminal attachment body and providing the fitting portion with a terminal pin that protrudes toward outside the arc tube.

### INDUSTRIAL APPLICABILITY

The present invention enables the terminal attachment body to be fixed to the base body in manufacturing a lamp even if an arc tube of the lamp has a small diameter, at the same time providing reliable insulation between the terminals and the base body.

1. A lamp comprising:
a straight arc tube; and
a pair of bases which each have a pair of terminals, and are each attached to an end of the arc tube, wherein
each base includes:
a base body that is shaped like a cap and has an opening in the center of an end wall that is an end surface of the base body; and
a terminal attachment body to which the pair of terminals are attached, the terminal attachment body being fixed to the base body with the terminals being protruded from the opening, and
a length of the end wall between the opening and a rim thereof along a diameter of the base is no smaller than an insulation distance that is defined in a standard for a purpose of keeping the base electrically safe, and the base has a portion where the length of the end wall exceeds a length of the end wall between the opening and the rim thereof in a direction in which the pair of terminals align.

2. The lamp of claim 1, wherein
the length of the end wall between the opening and the rim thereof is the shortest in the direction in which the pair of terminals align.

3. The lamp of claim 1, wherein
the length of the end wall in the direction in which the pair of terminals align is no smaller than 19 mm, and the length of the end wall in a direction perpendicular to the direction in which the pair of terminals align is no smaller than 11 mm and smaller than 19 mm.

4. The lamp of claim 3, wherein
the opening is oval and long in the direction in which the pair of terminals align.

5. The lamp of claim 1, wherein
the opening is oval and long in the direction in which the pair of terminals align.

6. The lamp of claim 5, wherein
the terminal attachment body includes a protuberant portion that is oval in a cross-sectional view and protrudes in a direction opposite to the arc tube along a tube axial of the arc tube, and the pair of terminals are attached to the terminal attachment body in an upper hollow of the protuberant portion so that the direction in which the pair of terminals align is substantially equal to a direction of length of the oval of the protuberant portion.

7. The lamp of claim 6, wherein
the terminal attachment body includes a disk-shaped bottom connected to the protuberant portion, the bottom and the protuberant portion having a same center, and the terminal attachment body is fixed to the base body with a pressure given to a rim of the bottom from the end wall of the base body.

8. The lamp of claim 7, wherein
the terminal attachment body includes a fitting portion that is formed between the protuberant portion and the bottom and fits into the opening.

9. The lamp of claim 8, wherein
two lead wires come out from each end portion of the arc tube and are respectively connected to the pair of terminals electrically, and the terminal attachment body further includes: two guide holes which guide the lead wires to positions where the lead wires are connected to the pair of terminals, respectively; and two metal members which are deposited in the guide holes and are electrically connected to the pair of terminals, respectively; and two pressing members that press the lead wires in the guide holes against the metal members, respectively.

10. The lamp of claim 7, wherein
the terminal attachment body has two protuberant walls that protrude from a surface of the bottom toward the arc tube, surrounding the guide holes, respectively.

11. The lamp of claim 6, wherein
the terminal attachment body includes a disk-shaped bottom under the protuberant portion, the bottom and the protuberant portion having a same center, and a surface of the bottom on the side of the protuberant portion is fixed to an inner surface of the end wall of the base body.

12. The lamp of claim 11, wherein
the terminal attachment body includes a fitting portion that is formed between the protuberant portion and the bottom and fits into the opening.

13. The lamp of claim 12, wherein
two lead wires come out from each end portion of the arc tube and are respectively connected to the pair of terminals electrically, and the terminal attachment body further includes: two guide holes which guide the lead wires to positions where the lead wires are connected to the pair of terminals, respectively; and two metal members which are deposited in the guide holes and are electrically connected to the pair of terminals, respectively; and two pressing members that press the lead wires in the guide holes against the metal members, respectively.

14. The lamp of claim 11, wherein
the terminal attachment body has two protuberant walls that protrude from a surface of the bottom toward the arc tube, surrounding the guide holes, respectively.

15. The lamp of claim 8, wherein
the terminal attachment body has two protuberant walls that protrude from a surface of the bottom toward the arc tube, surrounding the guide holes, respectively.

16. The lamp of claim 9, wherein
the terminal attachment body has two protuberant walls that protrude from a surface of the bottom toward the arc tube, surrounding the guide holes, respectively.

17. The lamp of claim 12, wherein
the terminal attachment body has two protuberant walls that protrude from a surface of the bottom toward the arc tube, surrounding the guide holes, respectively.

18. The lamp of claim 13, wherein
the terminal attachment body has two protuberant walls that protrude from a surface of the bottom toward the arc tube, surrounding the guide holes, respectively.
